(19) United States
(12) Patent Application Publication
(10) Pub. No.: US 2020/0356606 A1
(43) Pub. Date: Nov. 12, 2020

(54) INFORMATION PROCESSING DEVICE AND NON-TRANSITORY COMPUTER READABLE MEDIUM

(71) Applicant: FUJI XEROX CO., LTD., Tokyo (JP)

(72) Inventor: Toru OTSUKA, Kanagawa (JP)

(73) Assignee: FUJI XEROX CO., LTD., Tokyo (JP)

(21) Appl. No.: 16/587,123

(22) Filed: Sep. 30, 2019

(30) Foreign Application Priority Data
May 9, 2019 (JP) 2019-089106

(51) Int. Cl. G06F 16/93; G06K 9/00

(52) U.S. Cl. CPC G06F 16/93; G06K 2209/01; G06K 9/00483; G06K 9/00469

(57) ABSTRACT

An information processing device includes a first transmitter that transmits acquisition information to a target person, the acquisition information being information enabling acquisition of one or multiple stored documents that are documents stored in a specific area, a second transmitter that transmits storage information to the target person on a basis of the one or more stored documents acquired using the acquisition information, the storage information being information enabling storage, in a specific area, of a created document that is a document created by the target person, a document associator that associates the created document stored in the specific area using the storage information with the one or more stored documents, and a display controller that causes information about the created document and information about the one or more stored documents to be displayed in an associated state.

### CROSS-REFERENCE TO RELATED APPLICATIONS

This application is based on and claims priority under 35 USC 119 from Japanese Patent Application No. 2019-089106 filed May 9, 2019.

### BACKGROUND

### (i) Technical Field

The present disclosure relates to an information processing device and a non-transitory computer readable medium.

### (ii) Related Art

Japanese Unexamined Patent Application Publication No. 2010-170438 discloses a device including a unit that detects a search for another document using a search unit, and a unit that causes the detected other document and a re-stored document to be stored in association with each other in a storage unit. Japanese Unexamined Patent Application Publication No. 2001-142801 discloses a process that, when a user specifies an attached document included in a history display, displays email information corresponding to the history.

### SUMMARY

In some cases, a document is sent to a target person through a specific area, and in addition, the target person is requested to create a document based on the sent document. In this case, another document is newly created by the target person, and the created other document may be delivered by being stored in the specific area or the like. In this case, even though the other document has some kind of relationship with the first document (the other document is a document that the target person created by referring to information in the first document, or is a document obtained by adding to or commenting on the first document), the first document and the other document are basically handled as separate documents. In this way, a situation may occur in which a user has difficulty in understanding that there is a relationship between the first document and the other document, the user may need to remember the relationship between the first document and the second document by oneself, and convenience is impaired.

Aspects of non-limiting embodiments of the present disclosure relate to, in a case in which one or more stored documents are stored in a specific area and a document is created on the basis of the one or more stored documents acquired from the specific area and also stored in the specific area, making it easier for a user to understand that there is a relationship between the one or more stored documents and the created document compared to a case of not making an association between the one or more stored documents and the created document created on the basis of the one or more stored documents.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing device including a first transmitter that transmits acquisition information to a target person, the acquisition information being information enabling acquisition of one or a plurality of stored documents that are documents stored in a specific area, a second transmitter that transmits storage information to the target person on a basis of the one or more stored documents acquired using the acquisition information, the storage information being information enabling storage, in a specific area, of a created document that is a document created by the target person, a document associator that associates the created document stored in the specific area using the storage information with the one or more stored documents, and a display controller that causes information about the created document and information about the one or more stored documents to be displayed in an associated state.

### BRIEF DESCRIPTION OF THE DRAWINGS

An exemplary embodiment of the present disclosure will be described in detail based on the following figures, wherein:

FIG. 1 is a diagram illustrating an information processing system.

FIG. 2 is a diagram illustrating a configuration of a requesting terminal device and a creating terminal device.

FIG. 3 is a block diagram illustrating functions included in the requesting terminal device.

FIGS. 4A and 4B are diagrams illustrating emails transmitted by a requester.

FIGS. 5A and 5B are diagrams explaining associations made by a document association unit.

FIG. 6 is a diagram explaining a display process by a display control unit.

FIG. 7 is a diagram explaining a display process in a case in which “Delete” is selected by the requester or the like when information about a created document is being displayed.

FIGS. 8A and 8B are diagrams illustrating another example of screens displayed by the display control unit.

FIG. 9 is a flowchart illustrating the flow of a series of processes.

FIG. 10 is a diagram illustrating performed processes.

FIG. 11 is a diagram illustrating a screen referenced by the requester when requesting a document creator to create a created document.

FIG. 12 is a diagram illustrating a screen referenced by the requester when second information is created.

FIG. 13 is a diagram illustrating a screen displayed on a creating terminal device when a created document is uploaded.

FIG. 14 is a diagram illustrating processes executed when the requesting terminal device receives the created document.

FIG. 15 is a diagram illustrating a configuration of an external server.

### DETAILED DESCRIPTION

Hereinafter, an exemplary embodiment of the present disclosure will be described in detail and with reference to the attached drawings.

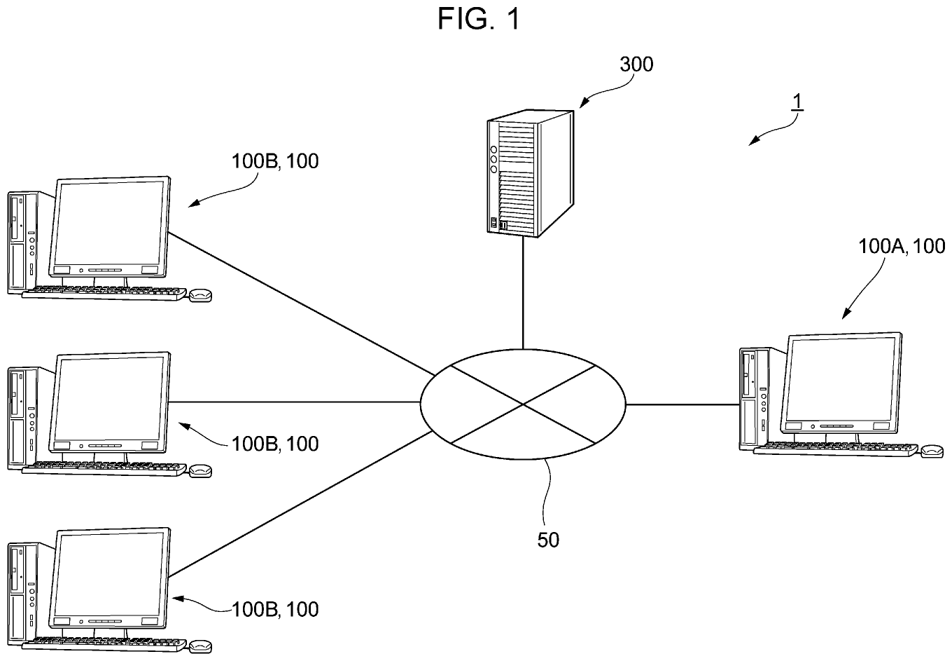

FIG. 1 is a diagram illustrating an information processing system 1 according to the exemplary embodiment.

The information processing system 1 according to the exemplary embodiment is provided with multiple terminal devices 100. In addition, the information processing system 1 is provided with an external server 300 that processes documents.

Each terminal device 100 that acts as one example of an information processing device is realized by a computer device. Also, the multiple terminal devices 100 are interconnected through a communication channel 50 such as the Internet. Also, the multiple terminal devices 100 and the external server 300 are interconnected through the communication channel 50.

Herein, at least one terminal device 100 among the multiple terminal devices 100 functions as a requesting terminal device 100A. The requesting terminal device 100A is a terminal device 100 used when requesting a target person to create a document.

Also, the other terminal devices 100 among the multiple terminal devices 100 function as creating terminal devices 100B, which are terminal devices 100 used when a target person creates a document.

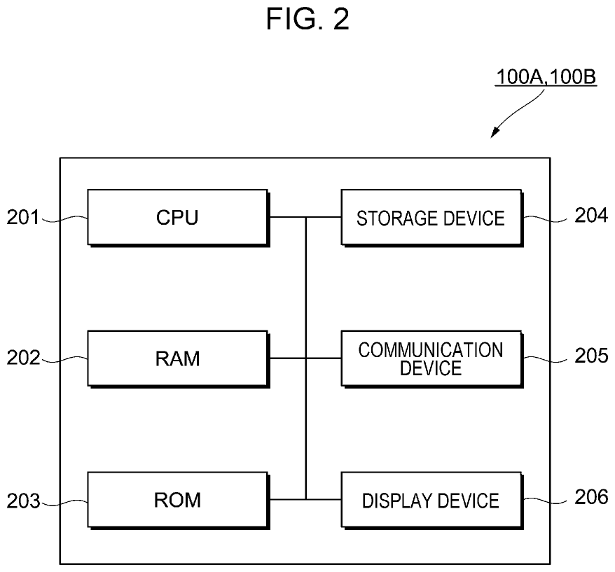

FIG. 2 is a diagram illustrating a configuration of the requesting terminal device 100A and the creating terminal devices 100B.

Each requesting terminal device 100A and creating terminal device 100B is provided with a central processing unit (CPU) 201, random access memory (RAM) 202, read-only memory (ROM) 203, a storage device 204 such as a hard disk, and a communication device (communication I/F) 205 for communicating with external devices. Also, each requesting terminal device 100A and creating terminal device 100B is provided with a display device 206 that displays information. The display device 206 is a liquid crystal display, for example.

The ROM 203 and the storage device 204 store programs executed by the CPU 201. The CPU 201 reads out a program stored in the ROM 203 or the storage device 204 and executes the program using the RAM 202 as a work area.

By having the CPU 201 execute one or more programs stored in the ROM 203 and the storage device 204, each function unit described later is realized.

Herein, a program executed by the CPU 201 may be provided to the requesting terminal device 100A and the creating terminal devices 100B in a recorded state on a computer-readable recording medium, such as a magnetic recording medium (such as magnetic tape or a magnetic disk), an optical recording medium (such as an optical disc), a magneto-optical recording medium, or semiconductor memory. Additionally, a program executed by the CPU 201 may also be provided to the requesting terminal device 100A and the creating terminal devices 100B using a communication medium such as the Internet.

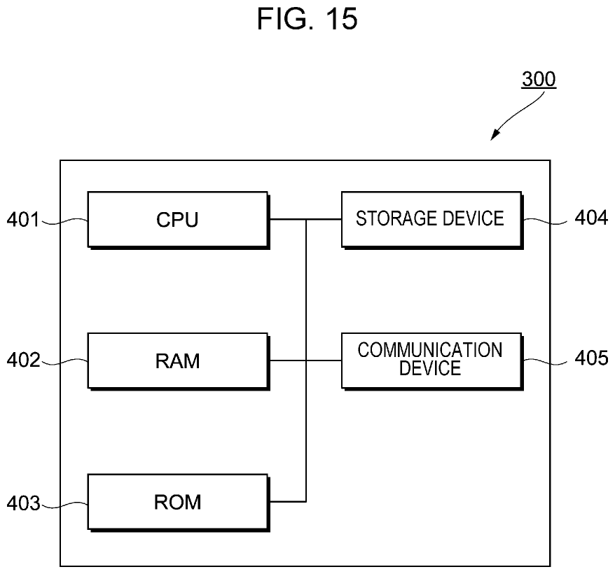

FIG. 15 is a diagram illustrating a configuration of the external server 300.

The external server 300 is provided with a central processing unit (CPU) 401, random access memory (RAM) 402, read-only memory (ROM) 403, a storage device 404 such as a hard disk, and a communication device (communication I/F) 405 for communicating with external devices.

The ROM 403 and the storage device 404 store programs executed by the CPU 401. The CPU 401 reads out a program stored in the ROM 403 or the storage device 404 and executes the program using the RAM 402 as a work area.

By having the CPU 401 execute one or more programs stored in the ROM 403 and the storage device 404, each function unit described later is realized.

Herein, a program executed by the CPU 401 may be provided to the external server 300 in a recorded state on a computer-readable recording medium, such as a magnetic recording medium (such as magnetic tape or a magnetic disk), an optical recording medium (such as an optical disc), a magneto-optical recording medium, or semiconductor memory. Additionally, a program executed by the CPU 401 may also be provided to the external server 300 using a communication medium such as the Internet.

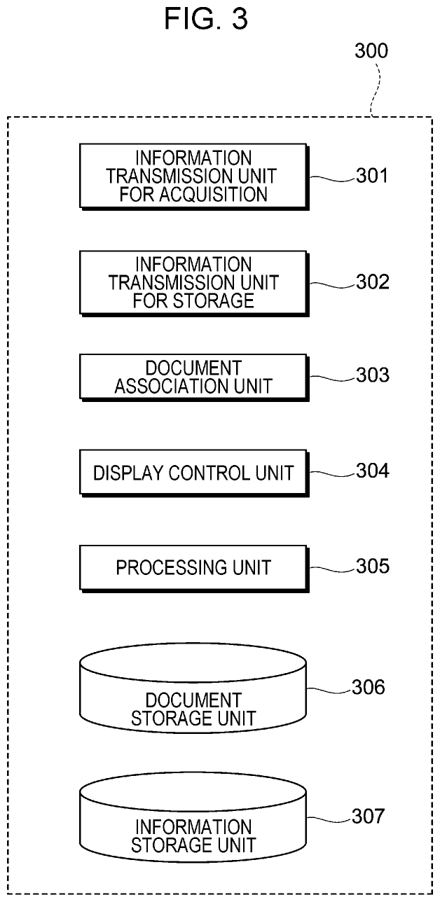

FIG. 3 is block diagram illustrating functions included in the external server 300.

The external server 300 is provided with an information transmission unit for acquisition 301, an information transmission unit for storage 302, a document association unit 303, a display control unit 304, a processing unit 305, a document storage unit 306, and an information storage unit 307.

Herein, the acquisition information transmission unit 301 and the storage information transmission unit 302 are realized by the communication device 405 and the CPU 401 executing a program stored in the ROM 403 or the storage device 404. The document association unit 303, the display control unit 304, and the processing unit 305 are realized by the CPU 401 executing a program stored in the ROM 403 or the storage device 404. Also, the document storage unit 306 and the information storage unit 307 are realized by the storage device 404.

The information transmission unit for acquisition 301 that acts as one example of a first transmitter, in response to an instruction from the requesting terminal device 100A, transmits acquisition information, that is, information enabling the acquisition of one or more documents stored in the document storage unit 306 (hereinafter referred to as the one or more “stored documents”) to a target person.

The information transmission unit for storage 302 that acts as one example of a second transmitter transmits storage information, that is, information enabling the storage of a created document created by the target person in the external server 300, to the target person.

Note that the transmitter that transmits the acquisition information and the transmitter that transmits the storage information may be the same or different from each other.

The document association unit 303 that acts as one example of a document associator associates the created document stored in the document storage unit 306 using the storage information with the one or more stored documents stored in the document storage unit 306.

The display control unit 304 that acts as one example of a display controller controls the display on the display device 206 provided in the requesting terminal device 100A, and causes information about the created document and information about the one or more stored documents to be displayed in an associated state.

In a case in which a specific process is performed on one document of either the created document or the one or more stored documents associated with each other by the document association unit 303, the processing unit 305 that acts as one example of a processor performs a process on the other document.

In the document storage unit 306, a document or documents (that is, the one or more stored documents) that serve as the basis for the created document created by the target person are stored. The created document is also stored in the document storage unit 306.

Information such as identification information described later is stored in the information storage unit 307.

In the following description, a process for the case of transmitting one or more stored documents stored in the document storage unit 306 of the external server 300 to a target person and requesting the target person to create a document based on the one or more stored documents will be described.

More specifically, in the following description, a process for the case of transmitting one or more stored documents stored in a specific area of the external server 300, namely the document storage unit 306, to another terminal device 100 other than the external server 300, namely one of the creating terminal devices 100B, and requesting the target person to create a document based on the one or more stored documents will be described.

Furthermore, in the following description, a process for the case in which a created document is created by the target person and the created document is stored in the document storage unit 306 of the external server 300 will be described.

More specifically, in the following description, a process for the case in which a created document is created and stored by the target person, and the created document is stored in a specific area of the external server 300, namely the document storage unit 306, will be described.

Herein, the one or more stored documents and the created document above are basically separate documents, and when one attempts to refer to the one or more stored documents, the created document, and the like, a situation may occur in which it becomes difficult to understand that there is a relationship between the one or more stored documents and the created document.

Accordingly, in the exemplary embodiment, by performing the following process, it becomes easier to understand that there is a relationship between the one or more stored documents and the created document.

Described more fully using a specific example, a form of processing exists in which someone creates a created document, that is, a separate product created on the basis of one or more stored documents upon request, and additionally delivers the created document upon request.

In this form of processing, the request to create a document, the creation of the document, and the delivery of the document are not necessarily finished in a single cycle, and in some cases the request, creation, and delivery are performed multiple times.

For example, assume that a process is performed in which a first edition of specifications A and a first edition of specifications B are developed, a first edition of source code C is received, and after that, a second edition of the specifications A is developed, a second version of the source code C is received, and so on.

In this case, the one or more stored documents that are the document or documents from which the request originated and the created document that is the document created on the basis of the one or more stored documents are stored in the external server 300, and there are concerns that the correspondence relationship between the created document and the one or more stored documents serving as the basis for the created document may become difficult to grasp.

Accordingly, in the exemplary embodiment, by performing the following process, it becomes easier to understand that there is a relationship between the one or more stored documents and the created document.

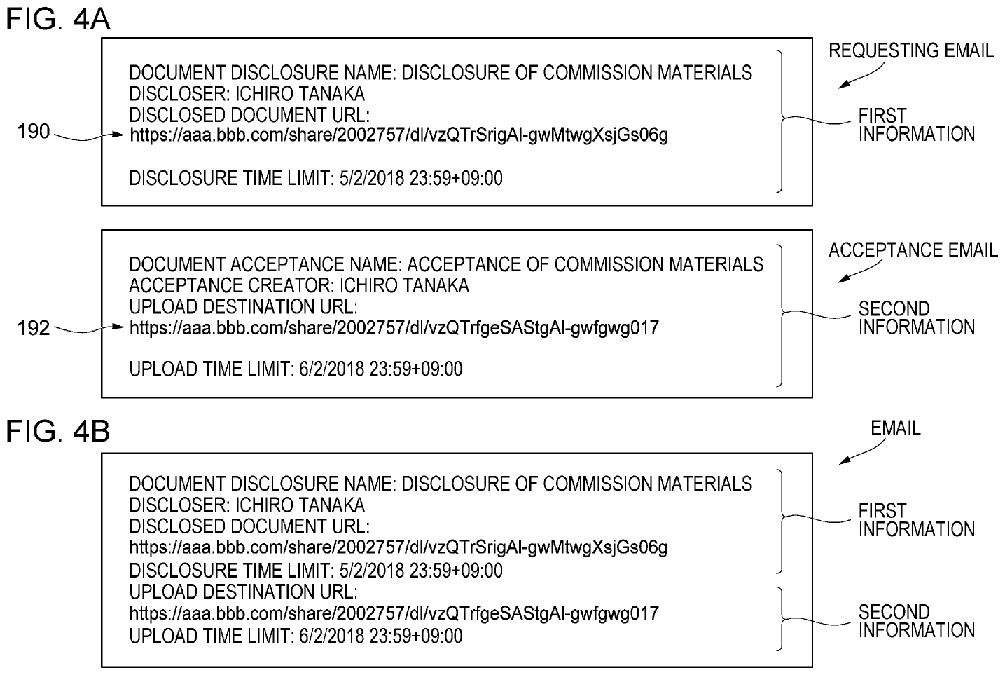

At this point, to make a request for the creation of a created document, first, a requester who makes the request for the creation of a document operates the requesting terminal device 100A to transmit the emails illustrated in FIG. 4A (a diagram illustrating emails transmitted by the requester) to a target person (hereinafter referred to as the “document creator”).

Specifically, the requester transmits a requesting email that includes first information for requesting the creation of a document, and an acceptance email that includes second information for accepting the created document.

In this example, the requesting email contains acquisition information 190, which is information enabling the acquisition of the one or more stored documents by the document creator. One example of the acquisition information 190 is the stored document name(s), the sender of the stored document(s), a URL indicating the storage location where the stored document or documents are stored, and a time limit on acquiring the one or more stored documents.

As described earlier, the one or more stored documents are stored in the document storage unit 306 of the external server 300, and the requesting email contains the acquisition information 190, which is information enabling the acquisition of the one or more stored documents stored in the document storage unit 306.

Note that the first information including the acquisition information 190 is generated by the information transmission unit for acquisition 301.

Subsequently, the first information including the acquisition information 190 is transmitted to the document creator by the information transmission unit for acquisition 301. In other words, the first information including the acquisition information 190 is transmitted to one of the creating terminal devices 100B by the information transmission unit for acquisition 301.

When the document creator acquires the first information including the acquisition information 190, the document creator uses the acquisition information 190 to access the external server 300 and acquire one or more stored documents stored in the external server 300.

Subsequently, the target person creates the created document on the basis of the acquired one or more stored documents.

Herein, “creating the created document on the basis of the acquired one or more stored documents” refers to, for example, creating the created document by reading and citing information in the one or more stored documents, or adding to or commenting on a stored document and saving the result as a new document.

Also, the acceptance email contains storage information 192, which is information enabling the storage of the created document created by the document creator in the external server 300. One example of the storage information 192 is the receiver of the created document, a URL indicating the storage location where the created document is stored, and a time limit on the storage of the created document.

The second information including the storage information 192 is generated by the information transmission unit for storage 302.

Subsequently, the second information including the storage information 192 is transmitted to the document creator by the information transmission unit for storage 302. In other words, the second information including the storage information 192 is transmitted to one of the creating terminal devices 100B by the information transmission unit for storage 302.

With this arrangement, by using the storage information 192, the document creator is able to store (or in other words, transmit) the created document that he or she has created in the external server 300.

Note that although the case of transmitting the two emails of a requesting email and an acceptance email is described as an example herein, as illustrated in FIG. 4B, a single email may also be configured to contain both the first information and the second information.

Also, the storage location where the one or more stored documents are stored and the storage location where the created document is to be stored may be the same or different locations.

In the exemplary embodiment, when the created document is created by the document creator and the created document is transmitted to the external server 300, the created document is stored in the document storage unit 306 of the external server 300.

With this arrangement, in the exemplary embodiment, the one or more stored documents and the created document are stored in the external server 300.

As described earlier, in the exemplary embodiment, the one or more stored documents and the created document are basically separate documents, and there are concerns that it may become difficult to understand that there is a relationship between the one or more stored documents and the created document.

For this reason, in the exemplary embodiment, the document association unit 303 associates the created document stored in the external server 300 utilizing the storage information 192 with the one or more stored documents (the document or documents from which the request originated) stored in the external server 300.

With this arrangement, a person such as the requester who requested the creation of the created document (the operator who operates the requesting terminal device 100A) more easily understands that there is a relationship between the one or more stored documents and the created document.

More specifically, in the exemplary embodiment, as described later, a display about a document is presented on the requesting terminal device 100A by the display control unit 304, and when an association is made by the document association unit 303 like in the exemplary embodiment, it is possible to present a display indicating that there is a relationship between the one or more stored documents and the created document.

With this arrangement, it becomes easier to understand that there is a relationship between the one or more stored documents and the created document.

In other words, in the exemplary embodiment, if an association between the one or more stored documents and the created document is made by the document association unit 303, when the display control unit 304 presents a display on the display device 206 of the requesting terminal device 100A, the display control unit 304 displays information about the one or more stored documents and information about the created document in an associated state.

With this arrangement, the requester or the like more easily understands that there is a relationship between the one or more stored documents and the created document.

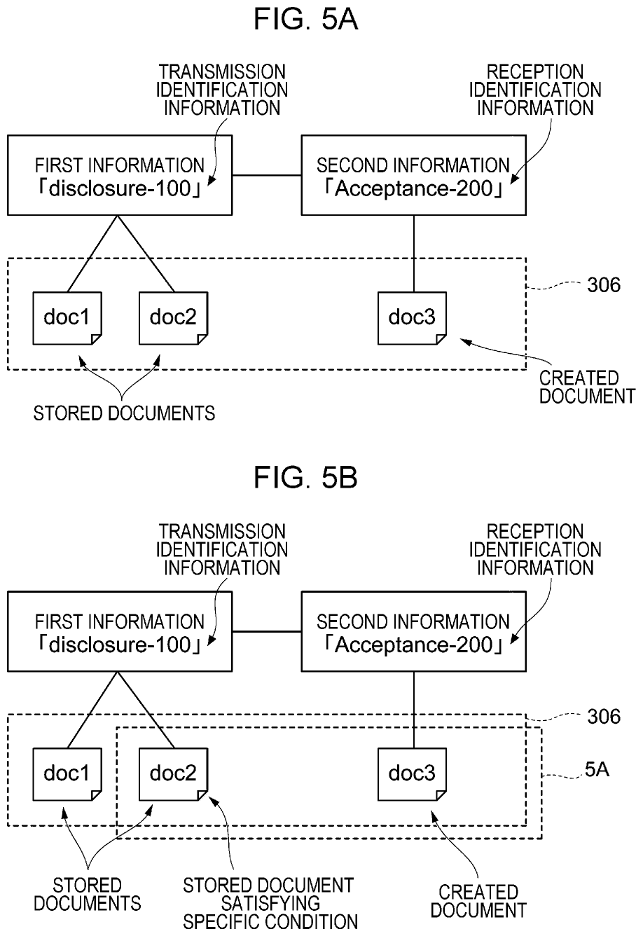

FIGS. 5A and 5B are diagrams explaining associations made by the document association unit 303.

In the case in which a created document is newly stored in the document storage unit 306 of the external server 300, as illustrated in FIG. 5A, the document association unit 303 associates the created document with each stored document already stored.

Herein, in the example illustrated in FIG. 5A, the document association unit 303 respectively associates the created document with all stored documents already stored.

Also, as another form of association, as indicated by the sign 5A in FIG. 5B, the document association unit 303 may also associate the created document with a stored document that satisfies a specific condition from among the stored documents.

Specifically, for example, the document association unit 303 may associate the created document with a stored document that was actually acquired by the target person from among the stored documents.

In other words, the document association unit 303 may associate a stored document that the document creator actually acquired by downloading from among the stored documents stored in the external server 300 with the created document created and uploaded by the document creator.

More specifically, in this case, the document association unit 303 references a download history saved in the external server 300 to ascertain which stored document was actually downloaded from among the multiple stored documents, for example.

Subsequently, the document association unit 303 associates the stored document that was actually downloaded with the created document. This is because a stored document that was actually downloaded is thought to have a stronger relationship with the created document than a stored document that was not downloaded.

The example illustrated in FIG. 5B illustrates that a document labeled “doc2” is a document that the document creator actually downloaded.

In this case, the document association unit 303 associates the created document “doc3” with the stored document “doc2” that was actually downloaded.

Otherwise, when associating a created document with one or more stored documents, the document association unit 303 may associate the created document with a stored document that satisfies a predetermined temporal parameter from among the stored documents. For example, the temporal parameter may stipulate that, at the point in time when the created document is stored, the date and time when the stored document was acquired by the document creator is within a specific period, the date and time when the stored document is stored is within a specific period, or in the case where a period of validity indicating a time limit on the acquisition of the stored document has been set, the period of validity is within a specific period.

Specifically, a case will be described for a parameter stipulating that the date and time when the stored document was acquired by the document creator is within one week from the point in time when the created document is stored. In the case where two stored documents exist, in which one stored document was acquired by the document creator three months before the point in time when the created document is stored, and the other stored document was acquired three days before the point in time, the stored document that was acquired three days before is associated with the created document. If the created document is stored a short time after the acquisition of a stored document, the relationship between that stored document and the created document is thought to be strong. Conversely, if the created document is stored a long time after the acquisition of a stored document, the relationship between that stored document and the created document is thought to be weak.

Otherwise, when associating a created document with one or more stored documents, the document association unit 303 may associate the created document with a stored document whose similarity with the created document is within a predetermined range from among the stored documents.

More specifically, for example, the document association unit 303 may specify a stored document having a name whose similarly to the name of the created document is within a predetermined range from among the stored documents, and associated the specified stored document with the created document.

Herein, the similarity between the created document and the stored document or the similarity between the name of the stored document and the name of the created document may be ascertained by comparing characters or words appearing in the created document itself or the name of the created document to characters or words appearing in the stored document itself or the name of the stored document, and ascertaining the similarity on the basis of the rate of concordance between the characters or words.

Also, in the case in which the stored document is a template such as a form, the document creator creates the created document by filling in items on the template, and therefore the stored document may be associated with the created document according to the layout of the stored document and the similarity to the written content.

Note that ascertaining similarity is not limited to the above techniques and may also be achieved by another publicly known technique.

Otherwise, the document association unit 303 may also associate a stored document whose creator matches the creator of a created document with the created document.

Herein, information about the creator may be added to a document as attribute information, and even if the document creator creates a created document such as by correcting part of a stored document, the attribute information may not change, and in some cases, the creator of the stored document and the creator of the created document match.

In such cases, the creator of the stored document and the creator of the created document stored in the document storage unit 306 will match, and if so, the document association unit 303 associates the stored document with the created document.

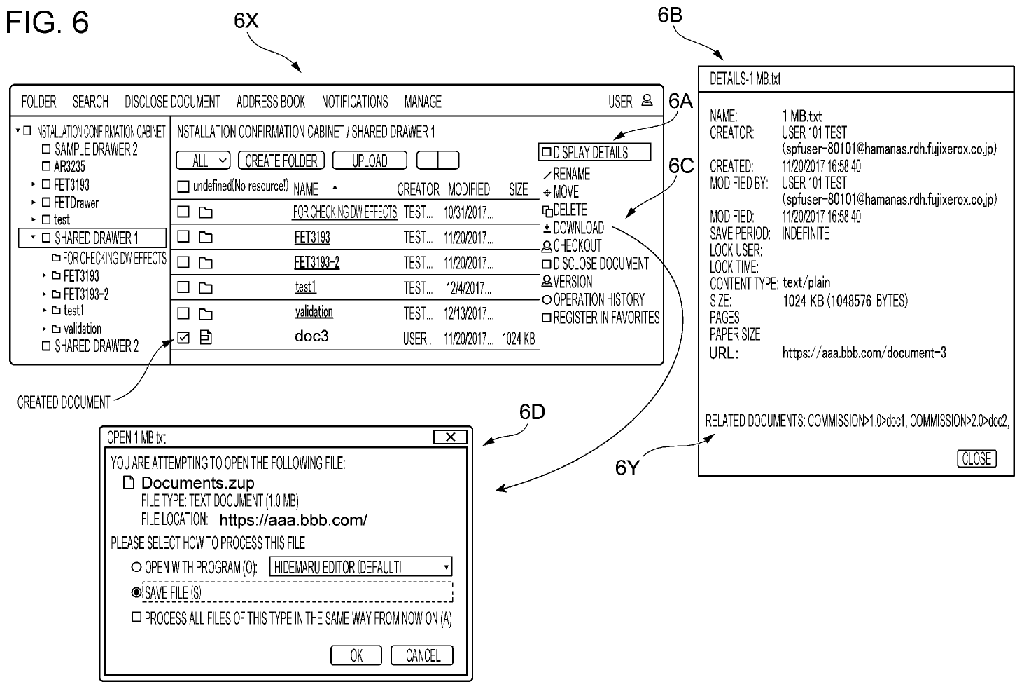

FIG. 6 is a diagram explaining a display process by the display control unit 304.

In the exemplary embodiment, when the display process is performed by the display control unit 304, a screen indicated by the sign 6X is displayed on the display device 206 of the requesting terminal device 100A, for example.

On the screen labeled 6X, information about created documents stored in the external server 300 is displayed. In this example, the name “doc3” of a created document is displayed.

In the exemplary embodiment, if the requester or the like performs an operation on this screen, and “Display details” indicated by the sign 6A is selected, for example, a screen indicated by the sign 6B is additionally displayed on the display device 206. In this example, a screen displaying details about the created document “doc3” is additionally displayed.

At the very bottom (at the location indicated by the sign 6Y) of this screen, a related document display field is provided. In the display field, information about stored documents “doc1” and “doc2” (the names of stored documents) that are related to the created document “doc3” is displayed.

Note that, although omitted from illustration, in the exemplary embodiment, if the operator selects the portion where the information about “doc0” and “doc2” is displayed, a screen displaying details about “doc1” and “doc2” is additionally displayed.

In other words, “doc1” and “doc2” are stored documents, and if the requester or the like selects the portion where “doc1” and “doc2” are displayed, a screen displaying details about the stored documents is additionally displayed.

Also, in the exemplary embodiment, if “Download” indicated by the sign 6C is selected, a screen indicated by the sign 6D is displayed.

Additionally, if an “OK” button is pressed on the screen indicated by the sign 6D, the three documents of the created document “doc3” and the stored documents “doc1” and “doc2” related to “doc3” are downloaded together.

In other words, in the exemplary embodiment, when downloading a single document, documents related to the single document are also downloaded in addition to the single document.

That is, in the exemplary embodiment, when downloading a created document, one or more stored documents related to the created document may also be downloaded in addition to the created document.

Also, although omitted from illustration, in the exemplary embodiment, when downloading a stored document, one or more created documents related to the stored document may also be downloaded in addition to the stored document.

Note that in the case in which both a created document and a stored document are downloaded in this way, the created document and the stored document may be combined and treated as a single document, and the single combined document may be downloaded.

Herein, FIG. 6 explains an example of a case in which information about stored documents is displayed as information related to the created document.

However, the configuration is not limited thereto, and by performing a predetermined operation, information about a stored document may also be displayed on the screen indicated by the sign 6X.

Additionally, on the screen displaying information about the stored document, if “Display details” indicated by the sign 6A is selected, information about one or more created documents related to the stored document is displayed.

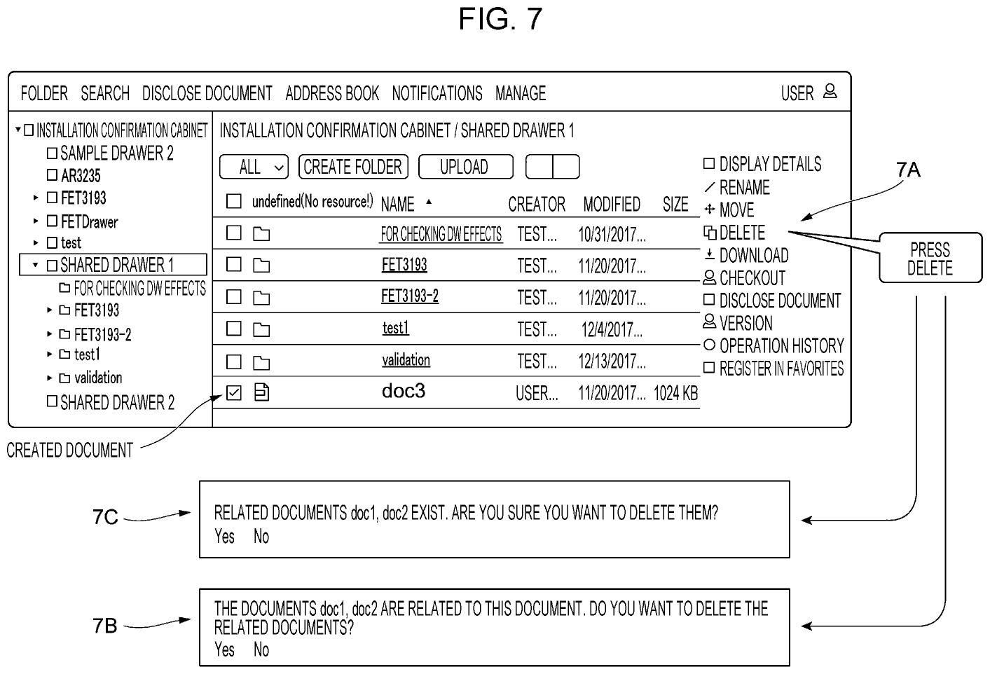

FIG. 7 is a diagram explaining a display process in a case in which “Delete” indicating by the sign 7A is selected by the requester or the like when information about the created document “doc3” is being displayed.

In the exemplary embodiment, if a specific process is performed on one document of either the created document or the stored document associated by the document association unit 303, the processing unit 305 performs a process on the other document.

In this example, the case in which one document, namely the created document, is deleted is given as an example. In this case, the processing unit 305 also performs a display process on the other document, namely the stored document.

Specifically, in the case in which the requester or the like gives an instruction to delete the created document “doc3”, as indicated by the sign 7C, the processing unit 305 displays an indication of the existence of “doc1” and “doc2” as related documents and also displays a confirmation of whether to delete “doc3”. Furthermore, as indicated by the sign 7B, the processing unit 305 displays a confirmation of whether to also delete the related documents “doc1” and “doc2”. Note that either or both of the confirmations indicated by the signs 7B and 7C may be displayed.

In other words, the processing unit 305 performs a display process indicating that “doc1” and “doc2” exist as related documents, and a display process for confirming whether to also delete “doc1” and “doc2” at the same time.

Subsequently, in the exemplary embodiment, in the case in which the operator gives a response agreeing to delete “doc1” and “doc2”, “doc1” and “doc2” are deleted in addition to deleting “doc3”.

With this arrangement, in the exemplary embodiment, the requester or the like is able to delete “doc1” and “doc2” more easily. More specifically, in this case, the operator is able to delete each document more easily without having to delete each document individually.

Note that although the above describes a process in the case where an instruction to delete the created document is given, in the case where an instruction to delete the stored document is given, a display indicating the existence of the created document may be presented similarly, and the operator may be similarly prompted to confirm whether to also delete the created document.

Also, the above describes a case in which when one document is deleted, the other document is deleted, but when one document is deleted, the other document may be protected.

For example, if one document is an old version and the other document is a new version, the old version of the document may be deleted in some cases, but if the above protection is performed, deletion of the new version of the document is deterred.

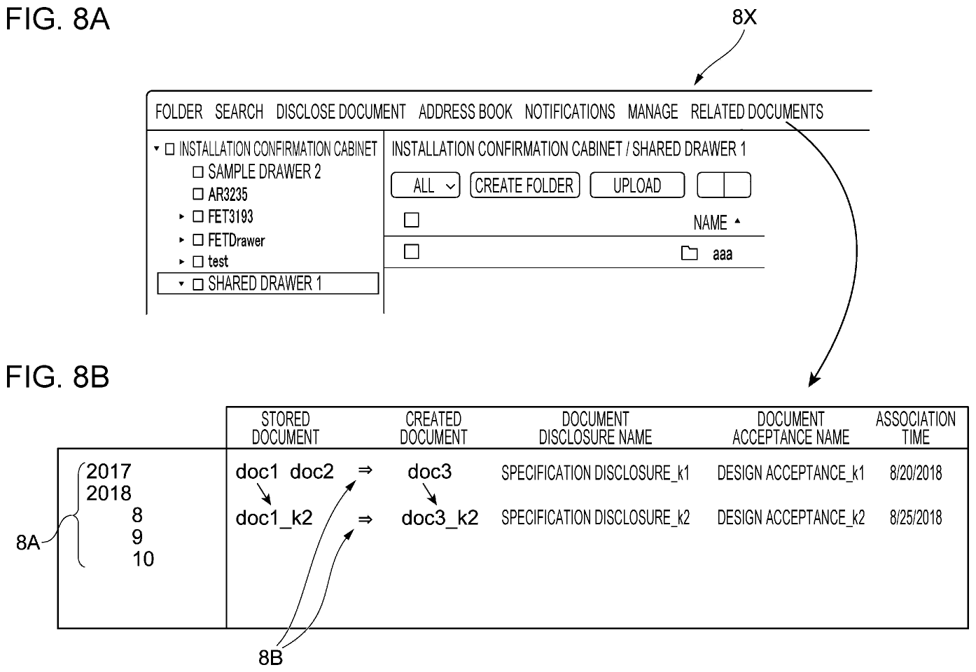

FIGS. 8A and 8B are diagrams illustrating another example of screens displayed by the display control unit 304.

FIG. 8B illustrates a screen that is displayed after the selection of “Related Documents” (refer to the sign 8X) displayed on the screen illustrated in FIG. 8A.

On the screen illustrated in FIG. 8B (the screen displayed after “Related Documents” is selected), “doc1” and “doc2” are displayed as stored documents, and the created document “doc3” is displayed beside “doc1” and “doc2”.

More specifically, “doc1” and “doc2” in the exemplary embodiment may also be understood as stored documents that were transmitted to the document creator.

On the screen of the exemplary embodiment, information about the stored documents “doc1” and “doc2” is displayed, and furthermore, the information “doc3” about the created document is displayed beside the information about “doc1” and “doc2”.

Additionally, on this screen, a document “doc1_k2” which is a revision of “doc1” is displayed, and furthermore, a created document “doc3_k2” created on the basis of “doc1_k2” is displayed.

Additionally, on this screen, as indicated by the sign 8A, creation time information expressing the creation time of each document is displayed in association with each of the documents.

In this example, the display indicates that “doc1”, “doc2”, and “doc3” were created in 2017, while “doc1_k2” and “doc3_k2” were created in August 2018.

Herein, in the exemplary embodiment, documents are displayed arranged in a time series, with chronologically older documents displayed on top.

Also, in the exemplary embodiment, it is also possible to filter documents, and by inputting information such as a creator name, a requester name, and a document creator name, for example, stored documents and created documents related to these persons are specified.

Furthermore, on this screen, the arrows indicated by the sign 8B are used to indicate relationships between documents. In this display example, the existence of a relationship between the stored documents “doc1”, “doc2” and the created document “doc3” is displayed. Also, the existence of a relationship between the stored document “doc1_k2” and the created document “doc3_k2” is displayed.

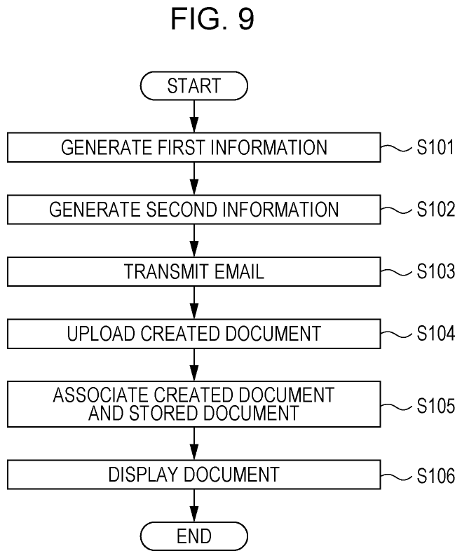

FIG. 9 is a flowchart illustrating the flow of a series of processes performed by the exemplary embodiment.

In the exemplary embodiment, first, when an instruction from the requester is given, the first information illustrated in FIG. 4A (information used to request the target person to create a document) is created (step S101). As described earlier, the first information includes the acquisition information 190.

Also, in the exemplary embodiment, when an instruction from the requester is given, the second information illustrated in FIG. 4A (information used to accept the created document) is created (step S102). As described earlier, the second information includes the storage information 192.

Next, in the exemplary embodiment, email is used to transmit the first information and the second information from the requester to the document creator (step S103).

After that, in the exemplary embodiment, the document creator uses the acquisition information 190 included in the first information to access the external server 300 and acquire one or more stored documents. Subsequently, the document creator creates the created document on the basis of the acquired one or more stored documents.

After that, in the exemplary embodiment, the document creator uploads the created document (step S104), and the created document is stored in the document storage unit 306 of the external server 300.

More specifically, in the exemplary embodiment, the storage information 192 included in the second information is used to transmit the created document to the external server 300, and the created document is stored in the document storage unit 306 of the external server 300.

Next, in the exemplary embodiment, the document association unit 303 associates the above created document stored in the document storage unit 306 using the storage information 192 with the stored document stored in the document storage unit 306 (step S105).

Note that, as described earlier, the association by the document association unit 303 may associate all stored documents stored in the document storage unit 306 with the created document, or associate a stored document satisfying a specific condition from among the stored documents with the created document.

After that, in the exemplary embodiment, if a predetermined condition is satisfied, such as when an instruction from the requester or the like is given, the display control unit 304 displays the stored document and the created document (step S106).

At this time, in the exemplary embodiment, as described earlier, the display control unit 304 displays information about the created document and information and the stored document in an associated state.

Herein, “displaying in an associated state” refers to displaying the documents in a state enabling one to understand that a relationship exists between the created document and the stored document, or displaying information indicating that a relationship exists between the documents.

Herein, one example of “displaying the documents in a state enabling one to understand that a relationship exists between the created document and the stored document” is displaying information about the created document and information about one or more stored documents adjacent to each other as illustrated in FIG. 8, for example.

Note that although FIG. 8 explains one example of a case in which information about the created document and information about one or more stored documents is arranged horizontally, the information may also be displayed by being arranged vertically.

Also, another example of “displaying the documents in a state enabling one to understand that a relationship exists between the created document and the stored document” is using the same color or font to display characters indicating information about the created document and characters indicating information about one or more stored documents.

In other words, another example of “displaying the documents in a state enabling one to understand that a relationship exists between the created document and the stored document” is making the form of expression for displaying information about the created document and the form of expression for displaying information about one or more stored documents uniform or consistent with each other.

Also, one example of “displaying information indicating that a relationship exists between the documents” is displaying the wording “Related Documents” as illustrated in FIG. 6 (see sign 6Y), for example.

Also, another example of “displaying information indicating that a relationship exists between the documents” is displaying the “arrow” indicated by the sign 8B in FIG. 8.

Herein, “displaying information indicating that a relationship exists between the documents” may be reworded as displaying information other than information about the created document and stored document(s) to indicate that a relationship exists between the created document and the stored document(s).

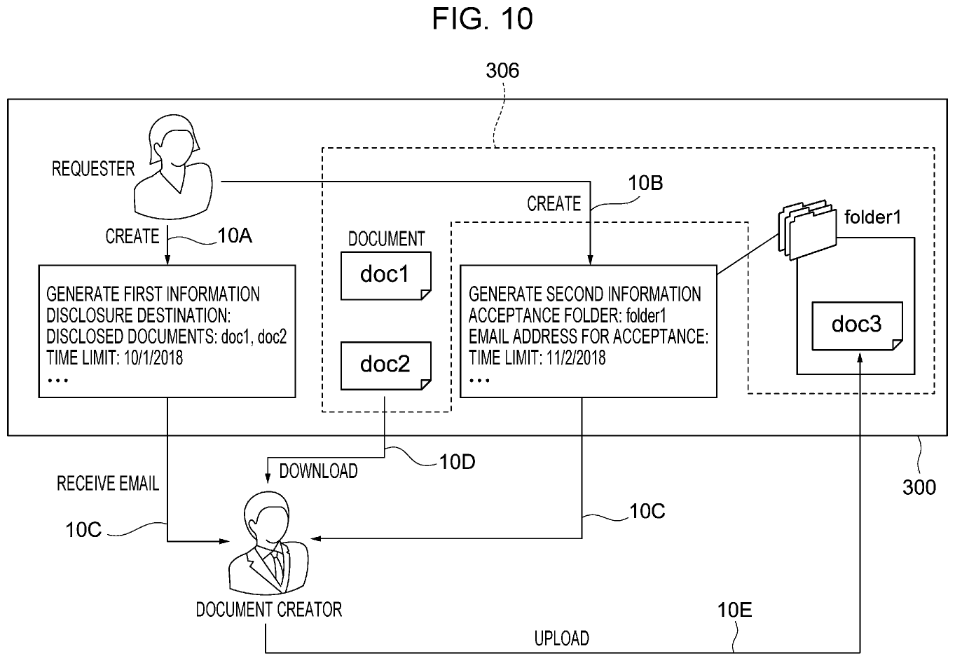

FIG. 10 is a diagram illustrating processes performed by the exemplary embodiment.

In the exemplary embodiment, first, as indicated by the signs 10A and 10B, and as described earlier, the first information and the second information are created according to an instruction from the requester. Subsequently, as indicated by the sign 10C, the first information and the second information are transmitted to the document creator.

Next, in the exemplary embodiment, as indicated by the sign 10D, the document creator uses the acquisition information 190 included in the first information to access the external server 300 and acquire one or more stored documents. This example illustrates a case in which “doc2” is acquired as the stored document.

After that, in this example, the document creator creates a created document “doc3” on the basis of “doc2”, and as indicated by the sign 10E, uploads “doc3” to the external server 300. When uploading, the storage information 192 included in the second information is used.

With this arrangement, in the exemplary embodiment, the created document “doc3” is stored in the document storage unit 306 of the external server 300.

After that, in the exemplary embodiment, the document association unit 303 associates either or both of the stored documents “doc1” and “doc2” with the created document “doc3”, for example.

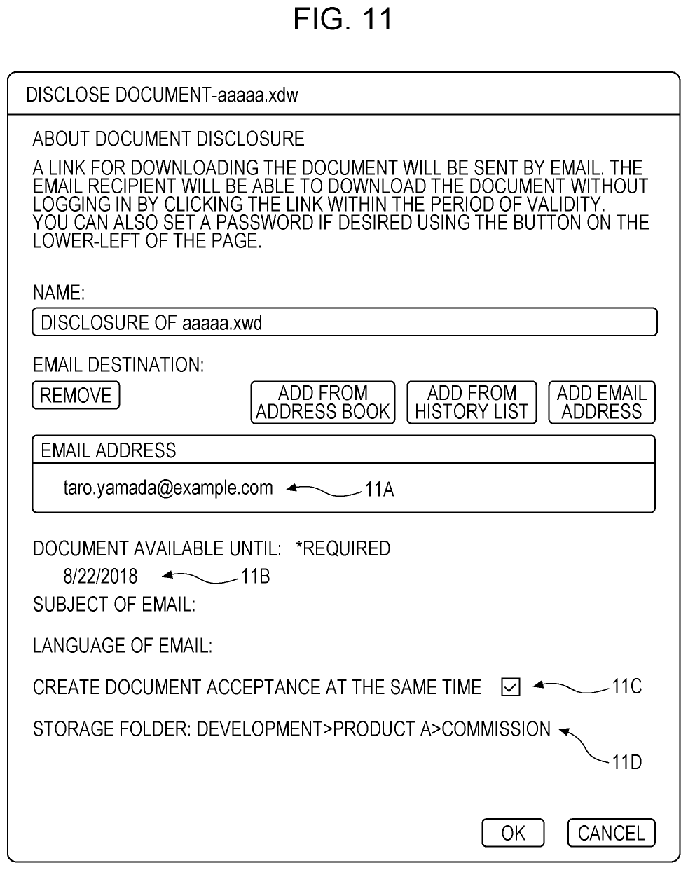

FIG. 11 is a screen displayed on the display device 206 of the requesting terminal device 100A, and is a diagram illustrating a screen referenced by the requester when requesting a document creator to create a created document.

In the case of requesting the document creator to create a created document, the requester inputs the email address of the document creator, as indicated by the sign 11A. More generally, the requester inputs information about the transmission destination of the first information.

Also, the requester sets a time limit on the availability of the one or more stored documents, as indicated by the sign 11B. More specifically, the requester inputs information about a time limit indicating for how long the one or more stored documents will be available for download.

Furthermore, on this screen, by selecting the area indicated by the sign 11C, the requester is able to set a setting for creating the second information in addition to the first information.

In the case of creating the second information in addition to the first information, the first information and the second information will be contained in a single email, as illustrated in FIG. 4B.

Furthermore, in this example, as indicated by the sign 11D, the requester sets a folder in which the created document is to be sorted and stored. In the exemplary embodiment, the created document stored in the document storage unit 306 is sorted into the set folder.

After that, in the exemplary embodiment, the external server 300 creates the first information on the basis of the input information, and transmits the first information to the document creator.

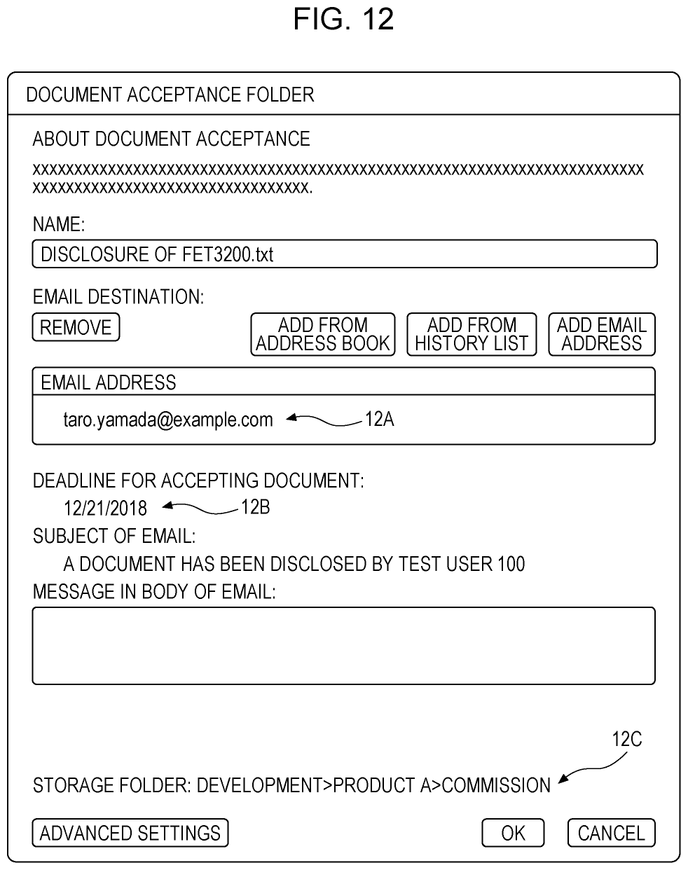

FIG. 12 is a diagram illustrating a screen referenced by the requester when the second information is created.

In the case of creating the second information separately from the first information (in the case in which the area indicated by the sign 11C in FIG. 11 is not checked), the screen illustrated in FIG. 12 is displayed.

On this screen, similarly to the above, and as indicated by the sign 12A, the requester inputs the email address of the document creator. More generally, the requester inputs information about the transmission destination of the second information.

Also, the requester sets a time limit related to the acceptance of the created document, as indicated by the sign 12B. More specifically, the requester inputs information about a time limit indicating for how long it is possible to upload the created document.

Furthermore, on this screen, as indicated by the sign 12C, the requester sets a folder in which the created document is to be sorted and stored. In this case, the created document stored in the document storage unit 306 is sorted into the set folder.

Note that in the exemplary embodiment, when the first information and the second information are created, identification information is assigned to each of the created first information and second information.

Specifically, in the exemplary embodiment, identification information “disclosure-100” (hereinafter referred to as “transmission identification information”) is assigned to the first information as illustrated in FIGS. 5A and 5B, for example. Also, identification information “Acceptance-200” (hereinafter referred to as “reception identification information”) is assigned to the second information, for example.

Also, in the exemplary embodiment, the transmission identification information and the reception identification information are stored associated with each other in the information storage unit 307 of the external server 300.

Furthermore, in the exemplary embodiment, the above one or more stored documents provided to the document creator are associated with the transmission identification information. In this example, as illustrated in FIG. 5A, the stored documents “doc1” and “doc2” are associated with the transmission identification information. In other words, in the exemplary embodiment, the transmission identification information and information about the one or more stored documents are associated with each other.

Furthermore, the transmission identification information and the information about the one or more stored documents associated with each other are stored in the information storage unit 307 of the external server 300 in association with each other.

Furthermore, in the exemplary embodiment, the reception identification information (“Acceptance-200”) is first encrypted and then included in the storage information 192 described earlier (see FIG. 4A).

In the exemplary embodiment, when the created document created by the document creator is transmitted to the external server 300, the storage information 192 that was used to transmit the created document is also transmitted to the external server 300.

Subsequently, the external server 300 decrypts the storage information 192 to obtain the reception identification information (“Acceptance-200”) included in the storage information 192.

Next, in the log management server 300, the transmission identification information (“disclosure-100”) associated with the reception identification information is specified, and in addition, one or more stored documents associated with the transmission identification information are specified.

With this arrangement, in the exemplary embodiment, one or more stored documents to be associated with the transmitted created document are specified. In other words, one or more stored documents that act as candidates for association with the created document are specified.

Subsequently, the document association unit 303 associates the one or more stored documents included among the one or more stored documents that act as candidates for association with the created document.

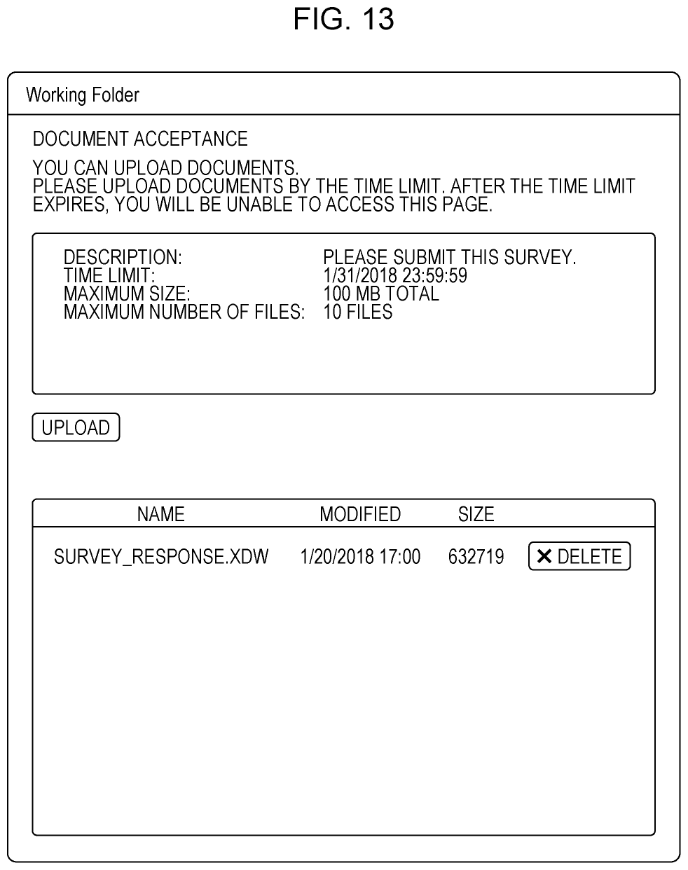

FIG. 13 is a diagram illustrating a screen displayed on the creating terminal device 100B when a created document is uploaded.

In the exemplary embodiment, when the document creator performs a predetermined operation, the screen illustrated in FIG. 13 is displayed on the creating terminal device 100B.

More specifically, when the document creator performs a predetermined operation, a screen used to upload a created document created by the document creator is displayed on the creating terminal device 100B.

The document creator performs an operation on the screen to specify the created document to upload, and additionally presses a Send button not illustrated.

With this arrangement, the storage information 192 described earlier is used to transmit the created document to the external server 300. Note that in the exemplary embodiment, as described earlier, the storage information 192 is also transmitted at this time to the external server 300.

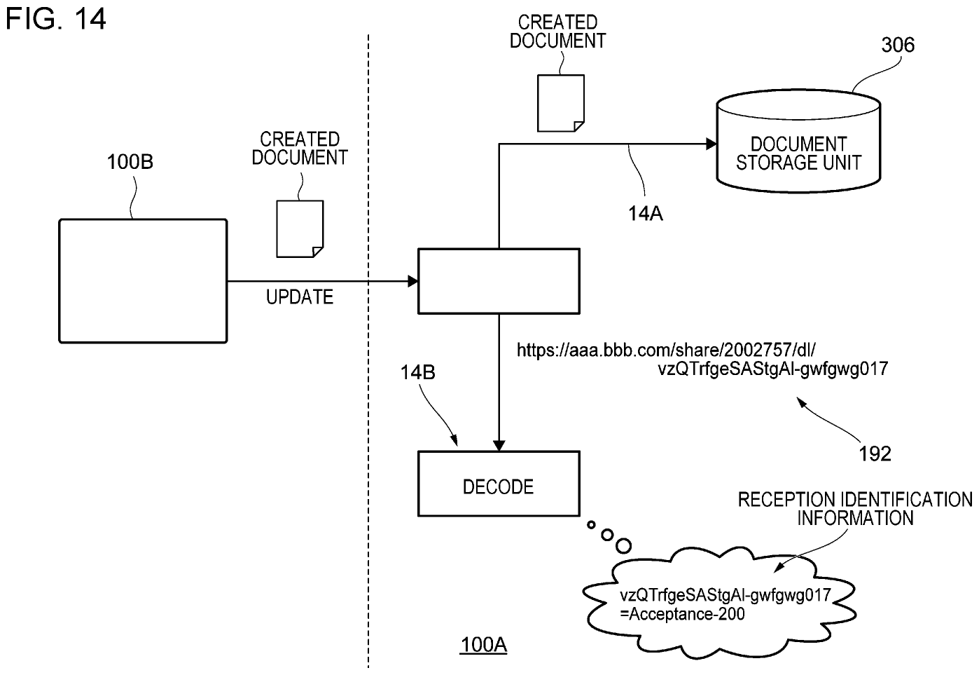

FIG. 14 is a diagram illustrating processes executed by the external server 300, which are executed when the external server 300 receives the created document.

In the exemplary embodiment when the external server 300 receives the created document, as indicated by the sign 14A, the created document is stored in the document storage unit 306 of the external server 300.

Also, in the exemplary embodiment, when the external server 300 receives the created document, the external server 300 acquires the storage information 192 that was used to transmit the created document.

More specifically, in the exemplary embodiment, when the created document is transmitted to the external server 300, the storage information 192 is also transmitted to the external server 300, and the external server 300 acquires this storage information 192.

Additionally, as indicated by the sign 14B, the external server 300 decrypts the storage information 192 to obtain the reception identification information. Specifically, in the exemplary embodiment, the above reception identification information called “Acceptance-200” is obtained.

Next, in the exemplary embodiment, a search process of searching the information stored in the information storage unit 307 is performed, and the transmission identification information (“disclosure-100”) associated with the reception identification information is specified.

Furthermore, in the external server 300, a search process of searching the information stored in the information storage unit 307 is performed, one or more stored documents associated with the transmission identification information (“disclosure-100”) are specified, and one or more stored documents that act as candidates for association with the created document are specified.

Subsequently, in the exemplary embodiment, the document association unit 303 associates the one or more stored documents included among the one or more stored documents that act as candidates for association with the created document.

Note that, although omitted from the above description, the document association unit 303 may also associate the created document stored in the document storage unit 306 with one or more stored document designated in advance.

More specifically, for example, the document association unit 303 may associate the created document stored in the document storage unit 306 with one or more stored documents designated by the requester (the requester described earlier who requests the creation of the created document) from among the one or more stored documents.

Also, for example, the document association unit 303 may associate the created document stored in the document storage unit 306 with one or more stored documents designated by the document creator from among the one or more stored documents.

Described more specifically, the requester may decide in advance one or more stored documents to associate with the created document from among multiple stored documents, and designate the one or more stored documents to be associated with the created document from among the multiple stored documents.

In the case of performing this process, the one or more stored documents designated by the requester are associated with the above transmission identification information. Subsequently, in this case, the document association unit 303 associates the created document with the one or more stored documents associated with the transmission identification information.

Also, the person who designates which of the stored document to associate is not limited to the requester, and may also be the document creator.

In the case in which the document creator designates one or more stored documents to be associated, multiple stored document candidates for association with the created document are displayed on the screen illustrated in FIG. 13, for example.

More specifically, information about the one or more stored document associated with the transmission identification information above are displayed.

Subsequently, on the screen illustrated in FIG. 13, a designation of one or more stored documents by the document creator is received (information about which of the stored documents to associate with the created document is received).

Additionally, in this case, when the created document is transmitted from the creating terminal device 100B to the external server 300, information about the one or more stored documents designated by the document creator is transmitted to the external server 300 in addition to the created document and the storage information 192.

Subsequently, in this case, the document association unit 303 associates the created document with the one or more stored documents designated by the document creator from among the multiple stored documents stored in the document storage unit 306 (from among the multiple stored documents associated with the transmission identification information).

Also, when associating the one or more stored documents with the created document, the email address described earlier may be used to associate the one or more stored documents with the created document.

In this case, for example, the email address used when transmitting the first information may be associated with information about one or more stored documents that are acquirable (downloadable) with the acquisition information 190 included in the first information, and stored in the information storage unit 307.

Subsequently, when the external server 300 receives the created document created and transmitted by the creator, the email address that was used for the transmission is ascertained by the external server 300.

Additionally, in the external server 300, the ascertained email address is extracted from among multiple email addresses stored in the information storage unit 307, and furthermore, the one or more stored documents associated with the email address are specified.

Subsequently, the document association unit 303 associates the created document with one or more stored documents included among the specified one or more stored documents.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising:
a first transmitter that transmits acquisition information to a target person, the acquisition information being information enabling acquisition of one or a plurality of stored documents that are documents stored in a specific area;
a second transmitter that transmits storage information to the target person on a basis of the one or more stored documents acquired using the acquisition information, the storage information being information enabling storage, in a specific area, of a created document that is a document created by the target person;
a document associator that associates the created document stored in the specific area using the storage information with the one or more stored documents; and
a display controller that causes information about the created document and information about the one or more stored documents to be displayed in an associated state.

2. The information processing device according to claim 1, wherein
the document associator associates the created document stored in the specific area with a stored document that satisfies a specific condition from among the one or more stored documents.

3. The information processing device according to claim 2, wherein
the specific condition is that the stored document was actually acquired by the target person.

4. The information processing device according to claim 2, wherein
the specific condition is a stored document that satisfies a predetermined temporal parameter.

5. The information processing device according to claim 2, wherein
the specific condition is a stored document whose similarity with the created document is within a predetermined range.

6. The information processing device according to claim 2, wherein
the specific condition is that a creator of the stored document matches a creator of the created document.

7. The information processing device according to claim 2, wherein
the specific condition is a stored document designated in advance.

8. The information processing device according to claim 7, wherein
the creation of the created document by the target person is performed in response to a request from a requester who requests the creation of the created document, and
the one or more stored documents to be associated by the document associator are designated by the requester.

9. The information processing device according to claim 7, wherein
the one or more stored documents to be associated by the document associator are designated by the target person.

10. The information processing device according to claim 1, further comprising:
a processor that, in a case in which a specific process is performed on one document of either the created document or the one or more stored documents associated with each other by the document associator, performs a process on the other document or documents.

11. The information processing device according to claim 10, wherein
in a case in which the one document is deleted, the processor performs a display process indicating that the other document or documents are associated.

12. The information processing device according to claim 10, wherein
in a case in which the one document is deleted, the processor deletes the other document or documents.

13. The information processing device according to claim 10, wherein
in a case in which the one document is deleted, the processor protects the other document or documents.

14. A non-transitory computer readable medium storing a program causing a computer to execute a process for processing information, the process comprising:
executing a first transmission of acquisition information to a target person, the acquisition information being information enabling acquisition of one or a plurality of stored documents that are documents stored in a specific area;
executing a second transmission of storage information to the target person on a basis of the one or more stored documents acquired using the acquisition information, the storage information being information enabling storage, in a specific area, of a created document that is a document created by the target person;
associating the created document stored in the specific area using the storage information with the one or more stored documents; and
causing information about the created document and information about the one or more stored documents to be displayed in an associated state.

15. An information processing device comprising:
first transmitting means for transmitting acquisition information to a target person, the acquisition information being information enabling acquisition of one or a plurality of stored documents that are documents stored in a specific area;
second transmitting means for transmitting storage information to the target person on a basis of the one or more stored documents acquired using the acquisition information, the storage information being information enabling storage, in a specific area, of a created document that is a document created by the target person;
document associating means for associating the created document stored in the specific area using the storage information with the one or more stored documents; and
display controlling means for causing information about the created document and information about the one or more stored documents to be displayed in an associated state.
